(19) United States
(12) Patent Application Publication
(10) Pub. No.: US 2015/0357081 A1
(43) Pub. Date: Dec. 10, 2015

(54) RESIN COMPOSITION WITH EXCELLENT SURFACE SMOOTHNESS

(71) Applicant: FURUKAWA ELECTRIC CO.,LTD., Tokyo (JP)

(72) Inventors: Koichi MIZUNO, Tokyo (JP); Hiroki CHIBA, Tokyo (JP); Tomoyuki SHIRAI, Tokyo (JP)

(73) Assignee: FURUKAWA ELECTRIC CO.,LTD., Tokyo (JP)

(21) Appl. No.: 14/760,443

(22) PCT Filed: Jan. 9, 2014
(86) PCT No.: PCT/JP2014/050183

§ 371 Date: Jul. 10, 2015

(30) Foreign Application Priority Data
Jan. 10, 2013 (JP) 2013-02615

(51) Int. Cl. H01B 7/02; C08L 23/12; H01B 3/44; C08L 23/06

(52) U.S. Cl. CPC H01B 7/0275; C08L 23/06; C08L 23/12; H01B 3/441

(57) ABSTRACT

Solved is the following problem in terms of outer appearance: a covered electric wire obtained by extrusion of a low cost linear polyethylene resin (LLDPE) has irregularities formed on the surface thereof because processing suitability of LLDPE is poor. As a solution to the problem, a resin composition including 50 to 97 parts by weight of LLDPE and 3 to 50 parts by weight of a polypropylene (PP) based resin can be used to thereby produce a covered electric wire excellent in surface smoothness at a high speed and a low cost.

### TECHNICAL FIELD

The present invention relates to a resin composition for a covered electric wire to be produced by extrusion, and relates to an inexpensive resin composition for covering an electric wire, which not only has excellent surface smoothness and productivity, but also has superior electric, thermal, dynamic and chemical properties compared with a conventional polyethylene covering material, as well as a covered electric wire using the resin composition.

### BACKGROUND ART

Electric wire and cable have two roles mainly of power transport and information transmission, and are used in everywhere of the society. An electric wire-covering material therefor is demanded to have electric insulation property, protection and anticorrosion properties of an electric wire, ease of handling of an electric wire or cable, and aesthetic appearance, and furthermore be efficient in covering. In recent years, the material has also been particularly demanded to have compatibility with the environment, flame retardance, safety and the like.

In power transport, there is divided to a transmission line that transmits electricity generated in a power plant to an electrical substation of a point of consumption, a distribution line that distributes electricity, whose voltage is reduced to a predetermined value at the electrical substation, to a factory, a building, a home or the like, furthermore, wiring for use in a factory, a building, or a home, and an electric wire for specialized equipment, for use in boat and ship, an airplane, an automobile or the like. On the other hand, in information transmission, there are exemplified an optical cable for use in a main line between telephone stations, an optical and metal code/cable for use in a station, an metal and optical cable for wiring between power poles, a cable to be drawn in a house, electric wire and cable for connection between electronic equipment in an office or a home, and a code or the like for connection between audio-video equipment such as a television, and furthermore, in recent years, there have been exemplified electric wire and cable in an electronic automobile.

An electric wire-covering material also related to the present invention is mainly directed to the field of a distribution line of several hundreds V or less in power transport, and the fields of an optical cable for use in a main line, an metal and optical cable for local wiring, and code and cable for connection between electronic equipment in an office or a home, in information transmission, and three kinds: a vinyl chloride (PVC) resin, a polyethylene (PE) resin and a crosslinked PE resin; are mainly used currently in terms of properties and a cost. Accordingly, in the above applications, while the electric wire-covering material is demanded to accomplish essential objects with respect to electric insulation property, protection and anticorrosion properties of an electric wire, and ease of handling of an electric wire or cable, it is also demanded to achieve extremely important factors of aesthetic appearance, a low raw material cost, and efficiency in covering (production cost). In addition, the electric wire-covering material is strongly demanded to be also compatible with the environment.

In view of the above, it is significant to develop an electric wire-covering material that realizes a cost comparable with the cost of PVC, as a material which has excellent properties of PE, such as electric insulation property, water-proofing and moisture-proofing properties, flexibility, and chemical resistance, and furthermore which is free of halogen causing a harmful substance to be generated.

Then, there has been studied whether or not linear LDPE (LLDPE) produced by an inexpensive low-pressure process, used in the form of a film thereof in large amounts, can be applied to the electric wire-covering material instead of low-density PE (LDPE) produced by a high-pressure process, mainly used as the electric wire-covering material currently.

PE is mainly classified to high density PE (HDPE), LDPE, LLDPE and metallocene LLDPE (PE polymerized using a metallocene catalyst). While PE, when industrially produced by an improved Ziegler-Natta catalyst in 1957, has allowed living wares to be drastically changed by means of properties and fabricability thereof, LLDPE industrially produced by a gas phase polymerization process in the U.S. in 1977 has also led to a large change in the plastic processing industry. The reason for this is because LLDPE produced by copolymerization of ethylene with an α-olefin through a Ziegler-Natta catalyst has been excellent in mechanical strength, heat resistance and hot sealability as compared with LDPE, and has been superior in sealing strength, impact resistance, hot tack property and the like as compared with Surlyn (registered trademark: PE ionomer). Therefore, conventional LDPE has been substituted with LLDPE mainly in a packaging material in terms of applications.

Furthermore, LLDPE produced by copolymerization of ethylene with an α-olefin through a metallocene catalyst developed by Professor Kaminsky et al. in 1980, having a narrower molecular weight distribution and being superior in low-temperature sealability and strength compared with the above LLDPE, has been industrially produced in the 1990's and has been necessary as a packaging material in the 2000's (see Non Patent Literature 1 and Non Patent Literature 2).

That is, it has been considered that LLDPE produced in large amounts in accordance with such technical development of PE can be applied to an electric wire-covering material to thereby provide an electric wire-covering material that is superior in electric, mechanical and thermal properties compared with conventional LDPE and that is free of halogen and furthermore low in cost.

In use of such LLDPE in an electric wire-covering material, however, there is a large problem due to the molecular structure of LLDPE, namely, the problem in terms of processing suitability. For example, it has been found that when Moretec 0138N (Prime Polymer Co., Ltd.: registered trademark) or Evolue SP2320 (metallocene LLDPE) (Prime Polymer Co., Ltd.: registered trademark) is used as commercial LLDPE to perform covering of an electric wire by common extrusion, remarkable irregularities are generated on the surface to make it impossible to satisfy the above required performance: aesthetic appearance; as shown in Table 1.

TABLE 1
Covering of electric wire with LLDPE by extrusion

| | | | | | | | Surface | |
|---|---|---|---|---|---|---|---|---|
| | | Properties of PE | | | | | roughness | Rating |
| PE | | MI | Density | α-Olefin | Content | | (μm) | results |
| Evolue SP2320 | Produced by Prime | 1.9 | 0.920 | C6 | 100 | | 13.1 | Poor |
| | Polymer Co., Ltd. | | | | | | | |
| Moretec 0138N | Produced by Prime | 1.3 | 0.917 | C8 | | 100 | 20.4 | Poor |
| | Polymer Co., Ltd. | | | | | | | |

LDPE by a high-pressure process, conventionally used for an electric wire-covering material, has a molecular structure having a long chain branch relative to a main chain, and has the following properties: high melt elasticity and a low response speed of the change in viscosity to temperature rise and temperature drop. While this is a large factor of poor hot sealability of LDPE, as described above, fabrication is facilitated on the contrary. On the other hand, LLDPE has a linear molecular structure having few branches relative to a main chain, and therefore has low melt elasticity and a high response speed of the change in viscosity to temperature rise and temperature drop. Therefore, while LLDPE is excellent in hot sealability and others: electric, mechanical and thermal properties; fabrication is more difficult on the contrary.

This problem is considered with a nozzle of an extruding machine as an example. When PE molten in the extruding machine is discharged outside through a nozzle, the normal stress effect specific to a viscoelastic body is exerted to provide a large and protuberant form. The temperature of PE here is dropped to convert a melt into a solid. The speed of such conversion is higher in LLDPE than LDPE, and therefore, while leveling is made in LDPE to provide a smooth surface, a solid is formed before leveling in LLDPE to cause the protuberant form by the normal stress effect to remain. In particular, as in covering and processing of an electric wire by extrusion, the Baras effect that is a specific swelling phenomenon observed in extrusion through a fine nozzle (see Non Patent Literature 3) is more remarkably exerted in high speed extrusion for an increase in productivity.

In response to such a problem, Japanese Patent Laid-Open No. 55-128441 (Patent Literature 1) has disclosed, as a method for an improvement in outer appearance of LDPE in extrusion, a method of mixing LDPE with a propylene based polymer such as polypropylene (PP) and a propylene-ethylene copolymer, but the method has been developed with respect to LDPE, neither LLDPE nor metallocene LLDPE has been present at this time, and this technique cannot be utilized. In fact, the MI of LDPE in Examples disclosed in pages 8 to 12 in Patent Literature 1 has been 20 which is a very large value as compared with that of LLDPE.

In Japanese Patent Laid-Open No. 9-306241 (Patent Literature 2), a covered electric wire having a smooth surface has been obtained by introducing a long chain branch to LLDPE by graft polymerization of a monomer having a polymerizable unsaturated group to modify the viscoelasticity behavior of LLDPE, but such a process has been complicated to impair properties of LLDPE.

Furthermore, Japanese Patent Laid-Open No. 10-120797 (Patent Literature 3) has disclosed a blend of an ethylene-α-olefin copolymer with PP, but no descriptions about the molecular structure and melting property of the ethylene-α-olefin copolymer have been provided, and whether or not the disclosure has been about LLDPE is not even clear. In addition, there has been the problem of surface roughening based on not the above viscoelasticity behavior but scorch in accordance with a crosslinking reaction.

Besides, a method of mixing high density polyethylene (HDPE) or medium density polyethylene (LDPE) has also been studied, but no sufficient improvement effect has been exerted.

Hereinabove, no technique for producing a covered electric wire excellent in surface smoothness and productivity by use of LLDPE has been found.

### CITATION LIST

### Patent Literatures

Patent Literature 1: Japanese Patent Laid-Open No. 55-128441
Patent Literature 2: Japanese Patent Laid-Open No. 09-306241
Patent Literature 3: Japanese Patent Laid-Open No. 10-120797

### Non Patent Literatures

Non Patent Literature 1: Prospect of Japan Plastic Industry in 2006, “Polyethylene”, Plastic Editorial Department, Plastics, 57 (1), 27, 2006.
Non Patent Literature 2: Latest Trend of Metallocene Polyethylene, edited by Takuya SERI, Convertech, 32 (10), 76, 2004.
Non Patent Literature 3: Engineering Plastics-Characteristics and Processing, edited by Yasushi OYANAGI, p. 74, 1985.

### SUMMARY OF INVENTION

### Technical Problem

The present invention is intended to solve the above conventional problems, and an object thereof is to provide a resin composition that not only enables to reduce surface roughening of a covered electric wire obtained by extrusion using LLDPE, but also enables to perform high speed extrusion, producing a covered electric wire excellent in surface smoothness and productivity, as well as a covered electric wire using the resin composition. Another object of the present invention is to provide a covered electric wire superior in electrical, thermal, dynamic and chemical properties compared with one using conventional LDPE.

### Solution to Problem

The above problems can be solved by finding that 3 to 50 parts by weight of a polypropylene (PP) based resin is combined with 50 to 97 parts by weight of LLDPE having a melt flow index (MI) of 10 or less to thereby provide a LLDPE-PP resin composition that can have a viscoelasticity behavior suitable for extrusion to produce a covered electric wire excellent in surface smoothness while physicochemical properties of LLDPE are not impaired. Furthermore, the above covered electric wire can be subjected to radiation crosslinking to thereby have more enhanced dynamic, thermal and chemical properties.

That is, in the present invention, it has been found that the above problems can be solved by providing a resin composition for covering an electric wire, including LLDPE having a MI of 10 or less and a PP based resin, and a covered electric wire produced using the resin composition.

### Advantageous Effects of Invention

Currently, while LLDPE is used in large amounts mainly for a packaging material and is necessary for a plastic processed product as an inexpensive general-purpose resin and also as a resin superior in dynamic, thermal and chemical properties compared with LDPE mainly used for covering an electric wire, LLDPE cannot be used as a resin for covering an electric wire because of causing irregularities in extrusion.

The present invention, however, provides a resin composition for covering an electric wire, which allows irregularities caused in extrusion to be eliminated to impart an excellent outer appearance and furthermore is inexpensive and excellent in productivity, and which has dynamic, thermal and chemical properties which LLDPE originally has, as well as a covered electric wire using the resin composition. In addition, the present invention can allow a PE-covered electric wire having superior dynamic, thermal and chemical properties compared with one by PVC to be applied to the field of a covered electric wire in which inexpensive PVC has been used as an insulating material.

### DESCRIPTION OF EMBODIMENTS

Hereinafter, embodiments of the present invention are described.

The present invention provides a resin composition for covering an electric wire, including 3 to 500 parts by weight of a PP based resin and 50 to 97 parts by weight of LLDPE having a MI of 10 or less, and a covered electric wire produced using the resin composition in an extruding machine for covering an electric wire.

3 to 50 parts by weight of the PP based resin can be combined with 50 to 97 parts by weight of LLDPE having a MI of 10 or less to thereby provide a viscoelasticity behavior suitable for extrusion, allowing a covered electric wire excellent in surface smoothness to be produced without causing physicochemical properties of LLDPE to be impaired, and preferably, 3 to 30 parts by weight of the PP based resin is combined with 70 to 97 parts by weight of the LLDPE. Further preferably, 5 to 15 parts by weight of the PP based resin is combined with 85 to 95 parts by weight of the LLDPE.

If the content of PP based resin is less than 3 parts by weight, irregularities caused in extrusion make it impossible to produce a covered electric wire having no problem in terms of outer appearance and being excellent in surface smoothness. On the other hand, if the content of PP based resin is 50 parts by weight or more, superior electric, dynamic, thermal and chemical properties, which LLDPE originally has, compared with LDPE conventionally adopted as a conventional electric wire-covering material are impaired.

The reason why the resin composition of the present invention has the effect of increasing surface smoothness of a covered electric wire produced by extrusion is not clear, but the present inventor considers the reason as follows.

LLDPE falls between HDPE being linear, having no branches and having a high crystallinity (density) and LDPE having a long chain branch relative to a main chain and having a low crystallinity (density), with respect to PE, and chemically has a molecular structure having a short chain branch relative to a main chain and physically falls therebetween in terms of crystallinity (density). It does not mean that only such a molecular structure allows all physical properties to be determined, but the structure allows hot sealability and low-temperature sealability of LDPE conventionally used as a packaging material to be largely improved. In addition, PE that can be produced by an invention of a metallocene catalyst has a narrow molecular weight distribution and furthermore is enhanced in terms of the above sealability, as compared with PE produced with a conventional Ziegler-Natta catalyst. Such an enhancement of the above sealability is due to a viscoelasticity behavior specific to a polymer from the viewpoints of crystallinity (high density) and monodispersibility (narrow molecular weight distribution) based on the above molecular structure.

That is, it is considered that, in extrusion of single LLDPE, a LLDPE melt is swollen by the normal stress effect specific to a viscoelastic body when discharged through a nozzle, and is solidified by air cooling at the same time as such discharging, but has a high crystallinity and therefore has a high speed of solidification in accordance with the cooling, to cause irregularities to be formed on the surface. It is presumed that, however, the PP based resin is added to thereby inhibit crystallization of LLDPE, allowing LLDPE in the above fabrication not to be solidified until the surface is smoothened, thereby providing a covered electric wire excellent in surface smoothness.

The reason why such an effect is effectively exerted particularly in a LLDPE-PP based resin composition is considered because, first, the LLDPE-PP based resin composition forms a phase separation system, and second, the density of the PP based resin is low. There is no example in which compatibility between different polymers having crystallinity is confirmed, and this LLDPE-PP based resin composition is also unexceptional. It is considered that intermolecular interaction is extremely weak in such a blend polymer and the PP based resin inhibits crystallization of LLDPE to result in a remarkable reduction in the speed of crystallization in cooling. Accordingly, even addition of PE having very high fluidity allows no effect to be exerted. That is, the same kind of polymers are compatible with each other to make it impossible to weaken intermolecular interaction, causing co-crystallization to thereby result in no reduction in the speed of crystallization in cooling.

Furthermore, while LLDPE, even though having a short chain branch, has a density of 0.91 to 0.94 g/cm³, a PP homopolymer has a density of 0.90 to 0.92, and a copolymer has a density equal to or less than the density of the PP homopolymer. The reason for this is because a methyl group is present and the free volume is large. It is considered that a LLDPE molecule comes into such a free volume to thereby further inhibit crystallization of LLDPE, resulting in a reduction in the speed of crystallization.

In the present invention, LLDPE is LLDPE having a MI of 10 or less, further preferably 5 or less. Such LLDPE is precisely an ethylene-α-olefin copolymer including an α-olefin having 4 to 8 carbon atoms as a copolymerization component, and may be synthesized using a conventional Ziegler-Natta catalyst or a metallocene catalyst without particular limitation, but is more preferably LLDPE for use in a film application.

Examples of main commercial LLDPE include product names such as Evolue SP2320 (Prime Polymer Co., Ltd.: registered trademark), Moretec 0138N (Prime Polymer Co., Ltd.: registered trademark), HONAM UF315 (Honam Petrochemical Corp.: registered trademark) and HONAM UF927 (Honam Petrochemical Corp.: registered trademark). Other examples include products such as Suntec (Asahi Kasei Chemicals Corporation: registered trademark), Umerit (Ube-Maruzen Polyethylene: registered trademark), Sumikasen (Sumitomo Chemical Co., Ltd.: registered trademark), Nipolon (Tosoh Corporation: registered trademark), Novatec (Japan Polyethylene Corporation: registered trademark) and L-LDPE (Dow Chemical Company).

The PP based resin having each MI, for use in the present invention, is used for various fabrications. Any of a homopolymer, a random copolymer and a block polymer can be used without particular limitation. Herein, a higher MI of the PP based resin is more preferable, and the MI is preferably 8 or more, further preferably 15 or more, more preferably 25 or more.

The copolymerization component of the PP based resin is generally ethylene, and a copolymer with 1-butene or a terpolymer with ethylene and 1-butene can also be used.

Examples of such a commercial PP based resin include products such as BC3A (Japan Polypropylene Corporation), BC8A (Japan Polypropylene Corporation), PB222A (Sunallomer Ltd.), VS200A (Sunallomer Ltd.) and PM900A (Sunallomer Ltd.). Other examples include products such as Sumitomo Noblen (Sumitomo Chemical Co., Ltd.: registered trademark) and Prime Polypro (Prime Polymer Co., Ltd.: registered trademark).

The resin composition for covering an electric wire of the present invention and the covered electric wire produced using the resin composition include at least LLDPE and the PP based resin, and if necessary, additives such as a colorant (pigment), an antioxidant, a lubricant, a dispersant, a copper inhibitor, an ultraviolet absorber and a flame retardant (carbon black, red phosphorus, tin compound, metal hydrate) can be added as long as the object of the present invention is not impaired.

In particular, the content of each of the colorant, the antioxidant and the lubricant is determined based on the amount of the PP based resin, and preferably, the amount of the colorant is 10 to 100 parts by weight, the amount of the antioxidant is 0 to 20 parts by weight and the amount of the lubricant is 0 to 20 parts by weight based on 100 parts by weight of the PP based resin. The content of each of other additives is also appropriately selected depending on the intended application, and the content is assumed to be an included number of the amount of the PP based resin and does not cause a ratio of the mixing contents of the PP based resin and LLDPE to be changed.

The colorant may include carbon black, and common various organic pigments may be used singly or in combinations of a plurality thereof. The antioxidant is selected from phenol based, sulfur based and phosphorus based antioxidants, and composites thereof. Furthermore, examples of the lubricant include hydrocarbon based, fatty acid based, ester based, alcohol based and silicon based lubricants, and hydrocarbon based and silicon based lubricants are preferable.

The covered electric wire by extrusion using the above resin composition is produced as follow. First, additives such as the colorant, the antioxidant and the lubricant are added to the PP based resin, and the resultant is molten and mixed by a Bunbury mixer or an extruder to prepare a PP based resin pellet. Next, this pellet is mixed with a LLDPE pellet immediately above an extruding machine, and the mixture is extruded in the form of an electric wire, with being molten and mixed. Alternatively, a PP based resin pellet including the above additives and a LLDPE pellet may also be molten and mixed by a Bunbury mixer, an extruder or the like to prepare a pellet of the resin composition for covering an electric wire in advance. Alternatively, LLDPE naturally or colored may also be mixed with only PP immediately above an extruder and the mixture may be extruded for covering.

On the other hand, the extruding machine for use in production of the covered electric wire of the present invention is not specialized, and a general-purpose extruding machine for production of an electric wire can be used therefor. The temperature of the extruding machine is preferably as follows: the temperature in a cylinder is about 160 to 200° C. and the temperature of a cross head is about 180 to 220° C.

Furthermore, in order to more enhance dynamic, thermal and chemical properties, the above covered electric wire may also be subjected to radiation crosslinking in the present invention. γ-Ray and/or electron beam can be used for the source of radiation, conventionally common apparatus and method can be used, and the density of crosslinking is required to be set depending on the intended application.

Hereinabove, the electric wire-covering material of the present invention is mainly directed to the fields of a distribution line of several hundreds V or less in power transport, and a communication cable for connection between stations and an electric wire for connection between electronic equipment in an office or a home in information transmission, in which three kinds of PVC, PE and crosslinked PE are mainly used in terms of properties and a cost, but encompasses all with which the periphery of conductors is covered as an electric wire-covering layer, and the structure is not particularly limited. The thickness of the covering layer, the thickness of each conductor, the number of conductors, and the like are not particularly different from conventional ones. These can be appropriately set depending on the type and the application of an electric wire.

### EXAMPLES

Hereinafter, the present invention is specifically described with reference to Examples and Comparative Examples, and is described in detail with reference to Table 2, Table 3, Table 4 and Table 5. Table 2 shows ratios of the respective mixing contents of film grade LLDPE and a PP based resin as main components and the evaluation results of surface smoothness of the linear covered insulator after extrusion in each of Examples 1 to 12, Table 3 shows those in each of Examples 13 to 19, Table 4 shows those in each of Examples 20 to 29, and Table 5 shows those in each of Examples 30 to 34.

### <Experimental Method>

As shown in Table 2, Table 3, Table 4 and Table 5, film grade LLDPE and a PP based resin were dry-blended at room temperature in each ratio of contents, and an extruding machine for production of an electric wire was used to cover an annealed copper wire having a conductor diameter of 0.8 mm with the above resin composition in a thickness of 0.8 mm by extrusion, to produce a covered electric wire. The speed of high speed extrusion was 5 m/min.

### <Evaluation Method>

The surface property of the electric wire produced was subjected to comparison by measuring the arithmetic average roughness using a surface roughness measurement machine (Surftest SJ-301 manufactured by Mitutoyo Corporation).

The experimental results were rated as: Excellent, Good, Fair and Poor; by measuring the surface roughness causing failure in outer appearance, namely, the height of an infinite number of micro protrusions as the numerical value, and both objectively and sensuously determining by way of an outer appearance test and a touching test. The line speed in high speed extrusion was constant, and the quality in forming at the extrusion speed was determined at a line speed set so that the quality was experientially evaluated. The rating criteria were defined as follows: Excellent: the surface was smooth and very even; Good: the surface was smooth and even; Fair: the surface was roughened and the quality was on the border; and Poor: the surface was remarkably roughened and was not adopted.

### <Experimental Results>

Table 2 shows the results obtained by selecting any of two kinds: Evolue SP2320 (Prime Polymer Co., Ltd.: trademark) and Moretec 0138N (Prime Polymer Co., Ltd.: trademark) as LLDPE and any of five kinds: BC3A and BC8A (Japan Polypropylene Corporation), and PB222A, VS200A and PM900A (Sunallomer Ltd.); as the PP based resin, producing respective resin compositions for covering an electric wire in trial in contents of the PP based resin of 0 parts by weight and 10 parts by weight, subjecting the resin compositions to covering by extrusion to provide covered electric wires, and comparing and rating the covered electric wires with respect to the surface roughness.

TABLE 2

| | | | | Comparative | | | | | |
|---|---|---|---|---|---|---|---|---|---|
| | | | | Example 1 | Example 1 | Example 2 | Example 3 | Example 4 | Example 5 |
| Evolue | Prime Polymer | MI = 1.9, | Content | 100 | 90 | 90 | 90 | 90 | 90 |
| SP2320 | Co., Ltd. | Density = 0.920 | | | | | | | |
| | | α-Olefin(C6) | | | | | | | |
| Moretec | Prime Polymer | MI = 1.3, | | | | | | | |
| 0138N | Co., Ltd. | Density = 0.917 | | | | | | | |
| | | α-Olefin(C8) | | | | | | | |
| BC3A | Japan | MI = 8.5, | Content | | 10 | | | | |
| | Polypropylene | Density = 0.900, | | | | | | | |
| | Corporation | b-PP | | | | | | | |
| BC8A | Japan | MI = 0.7, | | | | 10 | | | |
| | Polypropylene | Density = 0.900, | | | | | | | |
| | Corporation | b-PP(PP | | | | | | | |
| | | component = 85%) | | | | | | | |
| PB222A | Sunallomer Ltd. | MI = 0.8, | | | | | 10 | | |
| | | Density = 0.900, | | | | | | | |
| | | r-PP(PP | | | | | | | |
| | | component = 97%) | | | | | | | |
| VS200A | Sunallomer Ltd. | MI = 0.8, | | | | | | 10 | |
| | | homo PP | | | | | | | |
| PM900A | Sunallomer Ltd. | MI = 30, | | | | | | | 10 |
| | | Density = 0.900, | | | | | | | |
| | | homo PP | | | | | | | |
| Surface | | | | 13.1 | 1.9 | 5.5 | 3.06 | 8.61 | 1.39 |
| roughness | | | Rating | Poor | Good | Poor | Fair | Poor | Good |
| (μm) | | | | | | | | | |
| | | | | Comparative | | | | | |
| | | | | Example 2 | Example 6 | Example 7 | Example 8 | Example 9 | Example 10 |
| Evolue | Prime Polymer | MI = 1.9, | Content | | | | | | |
| SP2320 | Co., Ltd. | Density = 0.920 | | | | | | | |
| | | α-Olefin(C6) | | | | | | | |
| Moretec | Prime Polymer | MI = 1.3, | | 100 | 90 | 90 | 90 | 90 | 90 |
| 0138N | Co., Ltd. | Density = 0.917 | | | | | | | |
| | | α-Olefin(C8) | | | | | | | |
| BC3A | Japan | MI = 8.5, | Content | | 10 | | | | |
| | Polypropylene | Density = 0.900, | | | | | | | |
| | Corporation | b-PP | | | | | | | |
| BC8A | Japan | MI = 0.7, | | | | 10 | | | |
| | Polypropylene | Density = 0.900, | | | | | | | |
| | Corporation | b-PP(PP | | | | | | | |
| | | component = 85%) | | | | | | | |
| PB222A | Sunallomer Ltd. | MI = 0.8, | | | | | 10 | | |
| | | Density = 0.900, | | | | | | | |
| | | r-PP(PP | | | | | | | |
| | | component = 97%) | | | | | | | |
| VS200A | Sunallomer Ltd. | MI = 0.8, | | | | | | 10 | |
| | | homo PP | | | | | | | |
| PM900A | Sunallomer Ltd. | MI = 30, | | | | | | | 10 |
| | | Density = 0.900, | | | | | | | |
| | | homo PP | | | | | | | |
| Surface | | | | 20.40 | 1.61 | 1.16 | 3.01 | 1.86 | 0.55 |
| roughness | | | Rating | Poor | Good | Good | Fair | Good | Excellent |
| (μm) | | | | | | | | | |

It can be seen that the surface roughness is reduced by the PP based resin combined with the film grade LLDPE and a smooth surface shape is obtained.

PM900A (Sunallomer Ltd.) was used as the PP based resin to result in a remarkable enhancement in surface smoothness. Thus, a PP based resin of a grade high in MI, as typified by BC3A having a MI of 8.5 and PM900A having a MI of 30, tended to result in a good effect.

Table 3 shows the results obtained by selecting Evolue SP2320 (Prime Polymer Co., Ltd.) and PM900A (Sunallomer Ltd.) as LLDPE and the PP based resin, respectively, producing resin compositions for covering an electric wire in trial with the respective contents of LLDPE and the PP based resin being changed from 0 parts by weight to 50 parts by weight, subjecting the resin compositions to covering by extrusion to provide covered electric wires, and comparing and rating the covered electric wires with respect to the surface roughness.

TABLE 3

| | | | | Comparative | Comparative | Comparative | Example | Example | Example | Example |
|---|---|---|---|---|---|---|---|---|---|---|
| | | | | Example 3 | Example 4 | Example 5 | 11 | 12 | 13 | 14 |
| Evolue | Prime | MI = 1.9, | Content | 100 | 99 | 97 | 95 | 90 | 85 | 50 |
| SP2320 | Polymer Co., | Density = 0.920 | | | | | | | | |
| | Ltd. | | | | | | | | | |
| PM900A | Sunallomer | MI = 30, | Content | 0 | 1 | 3 | 5 | 10 | 15 | 50 |
| | Ltd. | Density = 0.900, | | | | | | | | |
| | | homo PP | | | | | | | | |
| MI(g/10 min) | | 190° C. × 2.16 kg | | 1.85 | 1.79 | 1.70 | 1.79 | 2.36 | 2.21 | 5.22 |
| Surface | | | | 13.1 | 13.0 | 11.9 | 1.86 | 1.00 | 0.80 | 0.93 |
| roughness | | | Rating | Poor | Poor | Poor | Good | Good | Excellent | Excellent |
| (μm) | | | | | | | | | | |

When the content of the PP based resin was more than 5 parts by weight, the surface smoothness was rapidly made better, and when the content was 15 to 50 parts by weight, a covered electric wire having a smooth surface was obtained constantly. When the amount of the PP based resin was more than 50 parts by weight, however, properties which LLDPE originally had were impaired.

Table 4 shows the results obtained by selecting any of two kinds: UF315 (Honam Petrochemical Corp.) and UF927 (Honam Petrochemical Corp.) as film grade LLDPE and using PM900A (Sunallomer Ltd.) as the PP based resin, producing resin compositions for covering an electric wire in trial with a ratio of the contents of LLDPE and the PP based resin being changed so that the amounts thereof were changed from 0 parts by weight to 10 parts by weight, subjecting the resin compositions to covering by extrusion to provide covered electric wires, and comparing and rating the covered electric wires with respect to the surface roughness.

TABLE 4

| | | | | Comparative | Comparative | Comparative | | |
|---|---|---|---|---|---|---|---|---|
| | | | | Example 6 | Example 7 | Example 8 | Example 15 | Example 16 |
| HONAM | HONAM | MI = 1.1, | Content | 100 | 99 | 98 | 97 | 95 |
| UF315 | | Density = 0.920 | | | | | | |
| HONAM | HONAM | MI = 1.1, | | | | | | |
| UF927 | | Density = 0.924 | | | | | | |
| PM900A | Sunallomer | MI = 30, homo | Content | | 1 | 2 | 3 | 5 |
| | Ltd. | PP | | | | | | |
| Surface | | | | 6.4 | | 3.2 | 0.55 | 0.51 |
| roughness | | | Rating | Poor | | Fair | Excellent | Excellent |
| (μm) | | | | | | | | |
| | | | | Comparative | Comparative | Comparative | | |
| | | | | Example 9 | Example 10 | Example 11 | Example 17 | Example 18 |
| HONAM | HONAM | MI = 1.1, | Content | | | | | |
| UF315 | | Density = 0.920 | | | | | | |
| HONAM | HONAM | MI = 1.1, | | 100 | 99 | 97 | 95 | 90 |
| UF927 | | Density = 0.924 | | | | | | |
| PM900A | Sunallomer | MI = 30, homo | Content | | 1 | 3 | 5 | 10 |
| | Ltd. | PP | | | | | | |
| Surface | | | | 16.4 | 11.5 | 4.07 | 1.03 | 1.35 |
| roughness | | | Rating | Poor | Poor | Poor | Good | Good |
| (μm) | | | | | | | | |

As is clear from the above Table, when the content of the PP based resin was more than 3 parts by weight, the effect of smoothing the surface was exerted. In particular, a combination of UF315 (Honam Petrochemical Corp.) with PM900A (Sunallomer Ltd.) as a combination of LLDPE with the PP based resin presented the best result. While the combination of LLDPE with the PP based resin is of importance, it can be seen that the amount of the PP based resin may be preferably at least 3 parts by weight.

In order to clarify such an effect of the PP based resin, studies were made by selecting any of two kinds: UF315 (Honam Petrochemical Corp.) and UF927 (Honam Petrochemical Corp.); as LLDPE and using two kinds: Suntec J311 (Asahi Kasei Chemicals Corporation: registered trademark) as injection molding grade HDPE and Umerit 613A (Ube-Maruzen Polyethylene: registered trademark) as LLDPE; instead of the PP based resin. Table 5 shows the results obtained by producing resin compositions for covering an electric wire in trial with the content of an alternative material for the PP being set to 5 parts by weight or 10 parts by weight, subjecting the resin compositions to covering by extrusion to provide covered electric wires, and comparing and rating the covered electric wires with respect to the surface roughness.

TABLE 5

| | | | | Comparative | Comparative | Comparative | Comparative | Comparative |
|---|---|---|---|---|---|---|---|---|
| | | | | Example 12 | Example 13 | Example 14 | Example 15 | Example 16 |
| HONAM | HONAM | MI = 1.1, Density = 0.920 | Content | 95 | 90 | | 90 | |
| UF315 | | | | | | | | |
| HONAM | HONAM | MI = 1.1, Density = 0.924 | | | | 90 | | 90 |
| UF927 | | | | | | | | |
| Suntec J311 | Asahi Kasei | MI = 26, Density = 0.956, | Content | 5 | 10 | 10 | | |
| | Chemicals | HDPE(injection) | | | | | | |
| | Corporation | | | | | | | |
| Umerit 613A | Ube-Maruzen | MI = 30, Density = 0.913, | | | | | 10 | 10 |
| | Polyethylene | LLDPE(injection) | | | | | | |
| Surface | | | | 15.5 | 10.0 | 10.4 | 10.5 | 13.8 |
| roughness | | | Rating | Poor | Poor | Poor | Poor | Poor |
| (μm) | | | | | | | | |

As is clear from the results, injection molding grade HDPE and LLDPE could not reduce irregularities on the surface of a covered electric wire with LLDPE based, although having a high MI of 26 or more. That is, it has been revealed that the solution of the present invention is effective.

### INDUSTRIAL APPLICABILITY

The resin composition for covering an electric wire of the present invention and the covered electric wire produced using the resin composition can be widely utilized in the fields of a distribution line of several hundreds V or less in power transport, and an electric wire for connection between electronic equipment in an office or a home in information transmission, in which three kinds of PVC, PE and crosslinked PE are mainly used, in terms of properties and a cost.

In addition, the present invention can be expected, with respect to a resin composition for covering an electric wire and a covered electric wire using the resin composition, to sufficiently exhibit superiority in productivity, marketability, functionality and the like in every electrical and electronic equipment industries, in addition to power transport and information transmission, and therefore is large in industrial applicability.

1. A resin composition for covering an electric wire, comprising 3 to 50 parts by weight of a polypropylene (PP) based resin and 50 to 97 parts by weight of linear low density polyethylene (LLDPE)

2. The resin composition for covering an electric wire according to claim 1, wherein the LLDPE is an ethylene-α-olefin copolymer that has an α-olefin having 4 to 8 carbon atoms and that has a melt flow index (MI) of 10 or less.

3. The resin composition for covering an electric wire according to claim 1, wherein the LLDPE is synthesized using a metallocene catalyst.

4. The resin composition for covering an electric wire according to claim 1, wherein the PP based resin comprises at least one of a homopolymer, a copolymer with ethylene, a copolymer with 1-butene, and a terpolymer with ethylene and 1-butene.

5. The resin composition for covering an electric wire according to claim 4, wherein a MI of the PP based resin is 15 or more.

6. The resin composition for covering an electric wire according to claim 1, comprising 65 to 97 parts by weight of LLDPE and 3 to 35 parts by weight of a resin composition comprising 100 parts by weight of the PP based resin together with 10 to 100 parts by weight of a colorant, 0 to 20 parts by weight of an antioxidant and 0 to 20 parts by weight of a lubricant.

7. A covered electric wire produced using the resin composition for covering an electric wire according to claim 1 by extrusion.

8. The resin composition for covering an electric wire according to claim 2, wherein the LLDPE is synthesized using a metallocene catalyst.
